(19) United States
(12) Patent Application Publication
(10) Pub. No.: US 2024/0365196 A1
(43) Pub. Date: Oct. 31, 2024

(54) COMMUNICATION CONTROL METHOD, TERMINAL DEVICE, BASE STATION AND READABLE STORAGE MEDIUM

(71) Applicant: BOE Technology Group Co., Ltd., Beijing (CN)

(72) Inventors: Li HAN, Beijing (CN); Feng QU, Beijing (CN); Biqi LI, Beijing (CN)

(21) Appl. No.: 18/029,885

(22) PCT Filed: Apr. 27, 2022
(86) PCT No.: PCT/CN2022/089579

§ 371 Date: Mar. 31, 2023

(51) Int. Cl. H04W 36/30; H04W 36/00; H04W 36/32

(52) U.S. Cl. CPC H04W 36/304; H04W 36/0058; H04W 36/0072; H04W 36/00835; H04W 36/324

(57) ABSTRACT

The present disclosure provides a communication control method, a terminal device, a base station and a readable storage medium. The method includes: between sending measurement control information and receiving a measurement report corresponding to the measurement control information, performing a preprocess for handover communication of a terminal device based on a current location of the terminal device to obtain handover request response information returned by a target base station.

### CROSS REFERENCE TO RELATED APPLICATIONS

This application is the national phase of International Application No. PCT/CN2022/089579 filed on Apr. 27, 2022, the disclosure of which is hereby incorporated by reference in its entirety.

### TECHNICAL FIELD

The present disclosure relates to the field of communication technologies, and in particular to a communication control method, a terminal device, a base station and a readable storage medium.

### BACKGROUND

With the high-speed, intelligent and informatization development of railway services, the introduction of 5G mobile communication technologies into railway industry will become the evolution direction of railway communication systems in the future, therefore, it is expected that high-speed railway mobile communication systems that support performance indicators such as high reliability, low delay, large capacity and ultra-high speed mobility adaptability can be built.

During the high-speed running of a train, the complex and changeable wireless environment or terrain environment along the railway will bring great challenges to the reliable communication of the high-speed railway mobile communication systems. Taking a handover as an example, when a user moves from the coverage of a base station to the coverage of an adjacent base station, in order to obtain better service quality, it is necessary for the user to disconnect from an original serving base station and then establish a new communication with an adjacent target base station. Due to a limited frequency bandwidth, when the train runs at high speed, the communication will be interrupted due to a handover failure, resulting in that requirements of passengers for quality of service (QOS) cannot be met.

### SUMMARY

The present disclosure provides a communication control method, a terminal device, a base station and a readable storage medium, so as to solve deficiencies in the related art.

According to a first aspect of an embodiment of the present disclosure, there is provided a communication control method, being applicable to a serving base station, including:
between sending measurement control information and receiving a measurement report corresponding to the measurement control information, performing a preprocess for handover communication of a terminal device based on a current location of the terminal device to obtain handover request response information returned by a target base station.

Optionally, performing a preprocess for handover communication of the terminal device based on the current location of the terminal device includes:
determining a preset switching point according to the current location of the terminal device; and
in response to that the terminal device reaches the preset switching point, sending a handover request to the target base station, so that the target base station executes an access control algorithm for the terminal device to determine whether to accept the handover request and returns the handover request response information to the serving base station when determining to accept the handover request.

Optionally, the method further includes:
obtaining the measurement report, wherein the measurement report is generated by the terminal device measuring signals of the serving base station and the target base station based on the measurement control information and is reported when the measurement report meets a preset measurement reporting criterion; and
delivering a handover command to the terminal device when the measurement report meets a preset handover decision algorithm, so that the terminal device synchronizes frequency with the target base station and reconfigures a radio resource control (RRC) connection according to an uplink resource and timing advance allocated by the target base station in response to receiving the handover command.

Optionally, the method further includes:
transferring sequence number (SN) state data to the target base station after delivering the handover command, so that the target base station sends a path handover request to a core network and sends a user context release instruction to the serving base station after obtaining a path handover request response; and
in response to obtaining the user context release instruction, releasing resources corresponding to the terminal device.

According to a second aspect of an embodiment of the present disclosure, there is provided a communication control method, being applicable to a terminal device, including:
obtaining a current location of the terminal device and measurement control information sent by a serving base station;
reporting the current location to the serving base station, so that the serving base station performs a preprocess for handover communication of the terminal device based on the current location to obtain handover request response information returned by a target base station;
measuring signals of the serving base station and the target base station based on the measurement control information and generating a measurement report;
reporting the measurement report to the serving base station when the measurement report meets a preset measurement reporting criterion, so that the serving base station makes a handover decision according to the measurement report and a preset handover decision algorithm after obtaining the handover request response information and delivers a handover command when the measurement report meets the preset handover decision algorithm; and
in response to receiving the handover command, synchronizing frequency with the target base station and reconfiguring a radio resource control (RRC) connection according to an uplink resource and timing advance allocated by the target base station.

Optionally, obtaining the current location of the terminal device includes:
obtaining a reference primary synchronization signal (PSS) sequence;
obtaining a secondary synchronization signal (SSS) sequence according to the reference PSS sequence;
determining a physical cell identity (PCID) according to the reference PSS sequence and the SSS sequence, and determining a base station location according to the PCID; and
determining the current location of the terminal device according to the base station location, a moving speed of the terminal device and a signal time difference.

Optionally, determining the current location of the terminal device according to the base station location, the moving speed of the terminal device and the signal time difference includes:
obtaining a time difference between any two signals sent by the serving base station at different time points to obtain a plurality of time differences;
for each of the plurality of time differences, calculating a distance difference of the terminal device according to the time difference and the moving speed of the terminal device to obtain a plurality of distance differences;
for each of the plurality of distance differences, establishing a hyperbola with the terminal device as a focus and the distance difference as a long axis to obtain a plurality of hyperbolas;
determining one or more intersections of the hyperbolas to obtain a location of the serving base station; and
calculating the current location of the terminal device according to the location of the serving base station and a distance difference corresponding to a latest time point.

Optionally, obtaining the current location of the terminal device includes:
when passing through a ground transponder, transmitting, by an inquiry transponder in the terminal device, a radio frequency signal to active the ground transponder between tracks, so that the ground transponder transmits preset information including location information; and
obtaining the location information in the preset information, and taking the location information as the current location of the terminal device.

According to a third aspect of an embodiment of the present disclosure, there is provided a base station, including:
a processor; and
a memory for storing a computer program executable on the processor,
wherein the processor is configured to execute the computer program in the memory to implement the method described above.

According to a fourth aspect of an embodiment of the present disclosure, there is provided a terminal device, including:
a processor; and
a memory for storing a computer program executable on the processor,
wherein the processor is configured to execute the computer program in the memory to implement the method described above.

According to the fifth aspect of the embodiment of the present disclosure, there is provided a train including an antenna module, a radio frequency front-end module and a baseband information processing module, wherein
the antenna module is configured to transmit and receive one or more electromagnetic wave signals;
the radio frequency front-end module is configured to convert one or more radio frequency signals and the electromagnetic wave signals; and
the baseband information processing module is configured to convert the radio frequency signals and one or more baseband signals,
wherein the baseband signals include at least one of a current location, measurement control information, measurement report, an uplink resource, timing advance, a reconfiguration completion instruction, a handover command, working frequency, a handover end identity or service data.

According to the sixth aspect of the embodiment of the present disclosure, there is provided a base station including an antenna unit, a radio frequency front-end unit, a central unit, a distribution unit and a power supply system, wherein
the power supply system is configured to supply power to the antenna unit, the radio frequency front-end unit, the central unit and the distribution unit;
the antenna unit is configured to receive and transmit one or more electromagnetic wave signals;
the radio frequency front-end module is configured to combine and divide paths, process data and modulate and demodulate one or more radio frequency signals and baseband signals; and
the central unit and the distribution unit are configured to process the baseband signals and exchange signaling with a core network.

According to a seventh aspect of an embodiment of the present disclosure, there is provided a computer readable storage medium, wherein, when an executable computer program in the computer readable storage medium is executed by a processor, the processor is configured to implement the method described above.

Technical solutions provided by the embodiment of the present disclosure can include the following beneficial effects.

As can be seen from the above embodiment, in the solutions provided by the embodiment of the present disclosure, between sending measurement control information and receiving a measurement report corresponding to the measurement control information, a preprocess is performed for handover communication of the terminal device to obtain handover request response information returned by the target base station. Therefore, compared with the solution that the handover is performed after obtaining the measurement report in the related art, the handover request response information can be obtained in advance in the embodiment of the present disclosure, so that the handover decision can be made directly after obtaining the measurement report, thereby reducing the time required for the handover, improving the success rate of the handover and meeting requirements of the user for quality of service.

It should be understood that the above general descriptions and subsequent detailed descriptions are merely illustrative and explanatory, and shall not constitute limitation to the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is an interaction diagram illustrating a communication control method according to an exemplary embodiment.

FIG. 2 is a flowchart illustrating a communication control method according to an exemplary embodiment.

FIG. 3 is a flowchart illustrating a method for obtaining a current location of a terminal device according to an exemplary embodiment.

FIG. 4 is a flowchart illustrating a method for obtaining a current location of a terminal device according to an exemplary embodiment.

FIG. 5 is a flowchart illustrating a method for performing a handover preprocessing according to an exemplary embodiment.

FIG. 6 is an interaction diagram illustrating a communication control method according to an exemplary embodiment.

FIG. 7 is a schematic architecture diagram of communication hardware of a train according to an exemplary embodiment.

FIG. 8 is a schematic architecture diagram of a base station according to an exemplary embodiment.

### DETAILED DESCRIPTION OF THE EMBODIMENTS

Exemplary embodiments will be described in detail here, examples of which are illustrated in the accompanying drawings. When the following description refers to the drawings, unless otherwise indicated, the same numerals in different drawings indicate the same or similar elements. The implementations set forth in the following description of exemplary embodiments do not represent all implementations consistent with the embodiments of the present disclosure. Instead, they are merely examples of apparatuses and methods consistent with aspects related to the embodiments of the present disclosure as recited in the appended claims. It should be noted that features in the following embodiments and implementations can be combined with each other without conflict.

### Noun Explanations

A terminal device refers to an electronic device (for example, a mobile phone or a tablet computer) or a relay device of a user.

A serving base station refers to a base station that currently communicates and transmits data with a terminal device.

A target base station refers to a base station to be handed over during a handover.

With the high-speed, intelligent and informatization development of railway services, the introduction of 5G mobile communication technologies into railway industry will become the evolution direction of railway communication systems in the future, therefore, it is expected that high-speed railway mobile communication systems that support performance indicators such as high reliability, low delay, large capacity and ultra-high speed mobility adaptability can be built.

During the high-speed running of a train, the complex and changeable wireless environment or terrain environment along the railway will bring great challenges to the reliable communication of the high-speed railway mobile communication systems. Taking a handover as an example, when the user moves from the coverage of a base station to the coverage of an adjacent base station, in order to obtain better service quality, it is necessary for the user to disconnect from an original serving base station and then establish a new communication with an adjacent target base station. Due to a limited frequency bandwidth, when the train runs at high speed, the communication will be interrupted due to a handover failure, resulting in that requirements of passengers for quality of service (QOS) cannot be met.

In the process of realizing the solutions of the present disclosure, inventors found that in the existing high-speed railway communication systems, when it is necessary for the train to hand over, the serving base station will send measurement control information to the terminal device; after receiving the measurement control information, the terminal device will measure signals of the target base station and the serving base station, generate a measurement report and report the measurement report when requirements are met. The serving base station makes a handover decision based on the measurement report. From the analysis of the above process, it can be seen that the serving base station is in a waiting state during a period between delivering the measurement control information and reporting the measurement report, resulting in a long handover time and a handover failure.

In order to solve the above technical problems, the embodiment of the present disclosure provides a communication control method, the inventive concept of which is that, between sending measurement control information and receiving a measurement report corresponding to the measurement control information, the serving base station performs a preprocess for handover communication of a terminal device based on a current location of the terminal device to obtain handover request response information returned by a target base station. After receiving the measurement report, the serving base station makes a handover decision instead of sending a handover request to the target base station, therefore, the time required for the handover can be reduced, the success rate of the handover can be improved and requirements of the user for quality of service can be met.

Considering that a communication system (for example, a 5G-R system) includes a terminal device, a serving base station and a target base station, a communication control method provided by the present disclosure will be described below with the terminal device. the serving base station and the target base station as execution bodies, respectively.

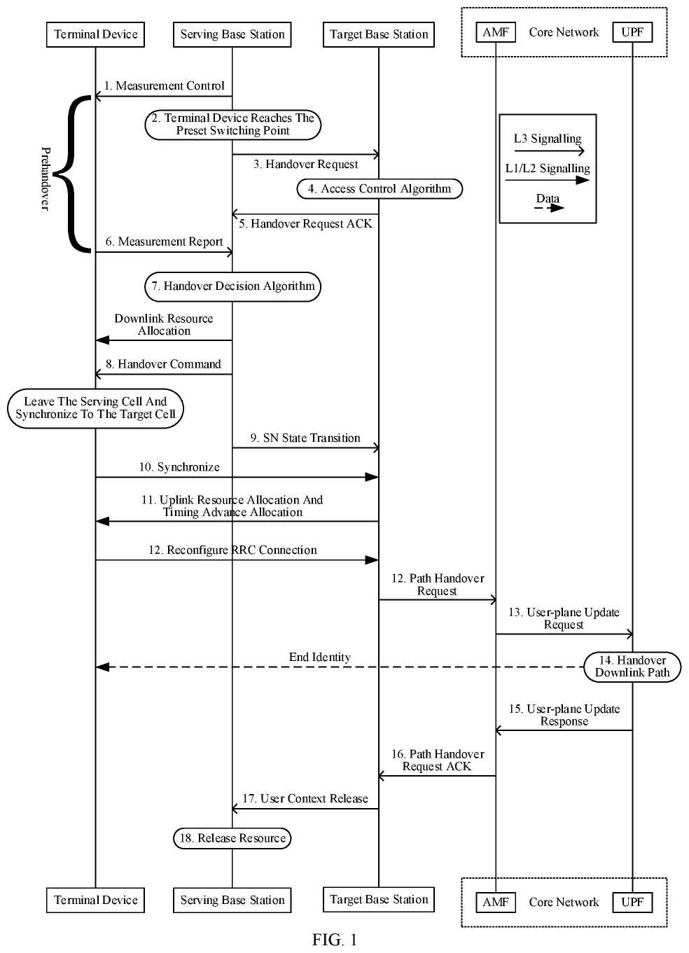

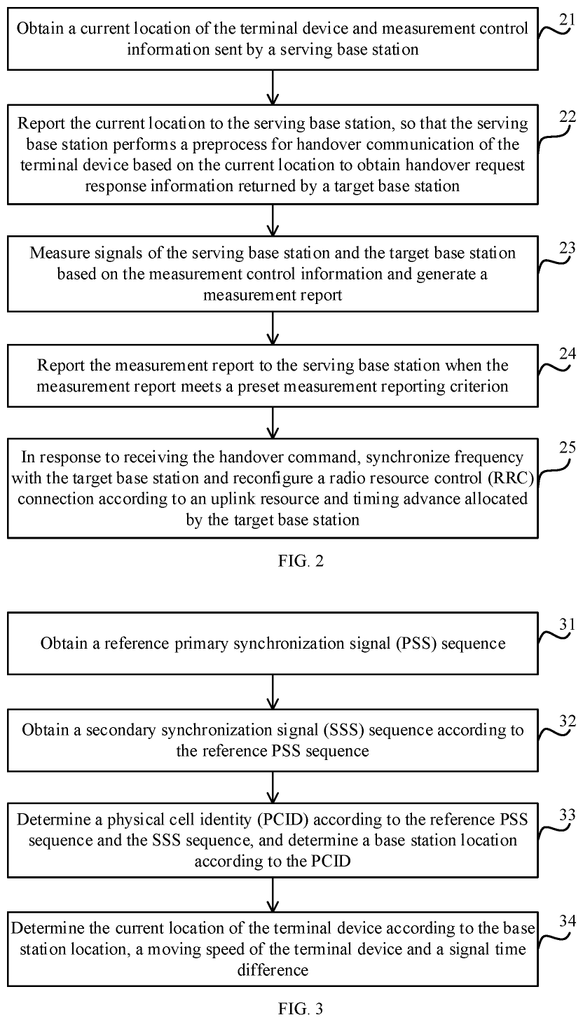

FIG. 1 is an interaction diagram illustrating a communication control method according to an exemplary embodiment, and FIG. 2 is a flowchart illustrating a communication control method according to an exemplary embodiment. Referring to FIG. 1 and FIG. 2, a communication control method is applicable to a terminal device and includes step 21 to step 25.

In step 21, a current location of the terminal device and measurement control information sent by a serving base station are obtained.

In this step, the terminal device can obtain the current location of the terminal device itself. Referring to FIG. 3, step 31 to step 34 are included.

In step 31, the terminal device can obtain a reference primary synchronization signal (PSS) sequence.

The terminal device can analyze a signal from the serving base station and obtain a primary synchronization signal (PSS) sequence in the signal. For example, the terminal device can perform correlation calculation on a received signal waveform and each of three possible PSS sequences (N_{ID}²=0,1,2) and extract a sequence that includes a correlation peak with the highest correlation. Since the PSS sequence is centered on a frequency, a location of the correlation peak with the highest correlation can indicate a deviation degree of a carrier center frequency, thereby realizing the coarse synchronization of the signal. In addition, the correlation peak with the highest correlation further indicates which of the three PSS sequences and a time instant of a best channel condition, therefore, the terminal device can determine the reference PSS sequence based on the correlation peak with the highest correlation, that is, N_{ID}².

In step 32, the terminal device can obtain a secondary synchronization signal (SSS) sequence according to the reference PSS sequence.

In this step, the terminal device can estimate an offset of a synchronization signal block (SSB) based on the reference PSS sequence. According to a structural diagram of the SSB, the PSS sequence is located in a center of the SSB, that is, an offset of the PSS sequence can represent the offset of the SSB. Then, the terminal device can perform time-frequency synchronization according to the above offset. After the time-frequency synchronization is completed, the terminal device can transform frequency spectrum carrying useful information near the carrier into a baseband, and then filter information of the baseband by using a filter to extract the SSB. Then, the terminal device can extract a resource element (RE) of a secondary synchronization signal (SSS) sequence in the SSB, perform correlation calculation on the above resource element and each of SSS sequences (N_{ID}¹=0,1,2, . . . ,335) locally generated and obtain the sequence that includes the correlation peak with the highest correlation to obtain the SSS sequence, that is, N_{ID}¹.

In step 33, the terminal device can determine a physical cell identity (PCID) according to the reference PSS sequence and the SSS sequence, and determine a base station location according to the PCID.

In this step, the terminal device can calculate a serving cell ID (also called the PCID) according to a relational expression N_{ID}=3N_{1D}¹+N_{ID}². In this way, the terminal device can determine the base station location of the serving base station according to the PCID.

In step 34, the terminal device can determine the current location of the terminal device according to the base station location, a moving speed of the terminal device and a signal time difference.

In one example, the terminal device can determine the current location of the terminal device according to the base station location, the moving speed of the terminal device and a signal time difference. Referring to FIG. 4, step 41 to step 45 are included. In step 41, the terminal device can obtain a time difference between any two signals sent by the serving base station at different time points to obtain a plurality of time differences. The terminal device can obtain a time difference between any two signals, that is, one time difference can be obtained by selecting two signals, so that a plurality of time differences can be obtained after multiple selections.

In step 42, for each of the plurality of time differences, the terminal device can calculate a distance difference of the terminal device according to the time difference and the moving speed of the terminal device to obtain a plurality of distance differences. When the moving speed of the terminal device is known, a distance between the terminal device and the serving base station (that is, the above distance difference) can be obtained by calculating a product of the moving speed and the time difference, so that the distance difference corresponding to each of the time differences can be obtained.

In step 43, for each of the plurality of distance differences, the terminal device can establish a hyperbola with the terminal device as a focus and the distance difference as a long axis to obtain a plurality of hyperbolas.

In step 44, the terminal device can determine one or more intersections of the hyperbolas to obtain a location of the serving base station. The terminal device is mobile, and the serving base station is fixed, therefore, every time a hyperbola is established with the terminal device as the focus and the distance difference as the long axis to obtain a plurality of hyperbolas, the serving base station is on each of the hyperbolas, and thus one or more intersections of the hyperbolas is the location of the serving base station.

In step 45, the terminal device can calculate the current location of the terminal device according to the location of the serving base station and a distance difference corresponding to a latest time point. Since the location of the serving base station is known, the distance difference between the serving base station and the terminal device is known, and a moving track of the terminal device is also known, the terminal device can calculate the current location of the terminal device. A process of calculating the current location of the terminal device can be converted into a process of finding a point whose distance from a known point is a known value (that is, the above distance difference) on a straight line in mathematics. Details can refer to related technologies, which will not be repeated here.

In another example, the terminal device can obtain the current location of the terminal device, that is, an inquiry transponder is arranged in the terminal device, and a ground transponder is arranged between tracks of the terminal device. When the terminal device passes through the ground transponder, a radio frequency signal transmitted by the inquiry transponder in the terminal device can active the ground transponder between the tracks, so that the ground transponder can transmit preset information including location information. At this time, the terminal device can obtain the location information in the preset information and take the location information as the current location of the terminal device.

In step 22, the current location is reported to the serving base station, so that the serving base station performs a preprocess for handover communication of the terminal device based on the current location to obtain handover request response information returned by a target base station.

In this step, the terminal device can report the current location to the serving base station. After receiving the current location, the serving base station can perform a preprocess for handover communication of the terminal device based on the current location to obtain the handover request response information returned by the target base station. For example, the serving base station can determine a preset switching point according to the current location of the terminal device. The preset handover point refers to a location that triggers a handover, and a triggering condition can be that reference signal strength of a target cell exceeds parameter signal strength of a serving cell by 1 dB to 4 dB, or the triggering condition can be that the reference signal strength of the target cell exceeds a preset threshold. The above reference signal strength can include reference signal receiving quality (RSRQ) or reference signal receiving power (RSRP), where the RSRP is an average value of signal powers received on all resource elements (Res) carrying a reference signal in a certain symbol. The terminal device can detect whether the terminal device reaches the preset switching point, send a handover request to the target base station in response to that the terminal device reaches the preset switching point, so that the target base station can execute an access control algorithm for the terminal device to determine whether to accept the handover request and return the handover request response information to the serving base station when determining to accept the handover request.

It should be noted that determining the preset switching point according to the current location of the terminal device means that the above preset threshold can be determined according to the current location, or the reference signal strength of the target cell exceeds the parameter signal strength of the serving cell. Considering different environments where the serving base station is located, the preset switching point can also be determined in combination with a channel condition. For example, in response to that the channel condition at the current location is relatively poor, the preset threshold can be a relatively small value; and in response to that the channel condition is relatively good, the preset threshold can be a relatively large value. In one example, the serving base station can store a table of preset switching points, and a value of the preset threshold can be directly queried in the table according to the current location and the channel condition, thereby improving the query efficiency.

In step 23, signals of the serving base station and the target base station are measured based on the measurement control information and a measurement report is generated.

In this embodiment, the terminal device can measure the signals of the serving base station and the target base station in response to receiving the measurement control information, wherein measurement parameters can include, but are not limited to, the RSRP, the RSRQ, a reference signal strength indicator (RSSI), a distance, and the like, and can be set according to specific scenarios. The terminal device can generate a measurement report after obtaining values of respective measurement parameters of the measurement parameters.

In order to eliminate interference caused by measurement error and channel mutation, the terminal device can perform filtering processing (that is, Layer-1 filtering and Layer-3 filtering) on the measurement report. The Layer-1 filtering means that a physical layer of the terminal device performs linear averaging on a series of single measurement sampling values of the physical layer in a certain period to finally obtain a result of the Layer-1 filtering. The Layer-3 filtering means that a weighted average processing is performed on a measurement result filtered by the Layer-1 and reported by the physical layer in the radio resource control (RRC) layer to obtain a measurement value in the measurement report.

In step 24, the measurement report is reported to the serving base station when the measurement report meets a preset measurement reporting criterion, so that the serving base station makes a handover decision according to the measurement report and a preset handover decision algorithm after obtaining the handover request response information and delivers a handover command when the measurement report meets the preset handover decision algorithm

In this embodiment, after obtaining the measurement control information, the terminal device can extract the preset measurement reporting criterion from the measurement control information. The measurement reporting criterion stipulates that various events can trigger the reporting criterion; an A1 event indicates that a measurement result of the serving cell is higher than a specified threshold; an A2 event indicates that the terminal device sends a measurement report to the serving base station when the measurement result of the serving cell is lower than the specified threshold; an A3 event means that when the measurement result of the target cell is higher than a certain threshold of the serving cell, the terminal device can send a measurement report to the serving base station, and the A3 event is a main event triggering criterion adopted for the handover; an A4 event indicates that the measurement result of the target cell is higher than the specified threshold; an A5 event means that when the measurement result of the serving cell is lower than the specified threshold and the measurement result of the target cell is higher than another specified threshold, the terminal device can report a result of the measurement report. The above measurement reporting criterion can be set according to the specific scenarios, which will not be limited here.

In this embodiment, after the measurement report is generated, the terminal device can determine whether the measurement report meets the above preset measurement reporting criterion. When the measurement report meets the preset measurement reporting criterion, the terminal device can report the measurement report to the serving base station, so that the serving base station can make a handover decision according to the measurement report and the preset handover decision algorithm after obtaining the handover request response information, and deliver the handover command when the measurement report meets the preset handover decision algorithm. At the same time, the serving base station can also deliver a downlink resource allocated by the target base station for the terminal device.

In step 25, in response to receiving the handover command, frequency is synchronized with the target base station and a radio resource control (RRC) connection is reconfigured according to an uplink resource and timing advance allocated by the target base station.

In this step, the terminal device can obtain a frequency of the target base station carried in the handover command in response to receiving the handover command. The terminal device can synchronize the frequency with the target base station and obtain the uplink resource and the timing advance allocated by the target base station; further, the terminal device can reconfigure the radio resource control (RRC) connection according to the uplink resource and the timing advance. After reconfiguring the RRC connection, reconfiguration completion information is returned to the target base station. At this time, the target base station can communicate with a core network to complete the handover and update a user-plane. After the downlink path is handed over, the core network can send a handover end identity to the terminal device, and the terminal device can communicate with the target base station and obtain data after receiving the handover end identity.

According to the embodiment of the present disclosure, by reporting the current location of the terminal device to the serving base station, the serving base station can perform a preprocess for handover communication of the terminal device based on the current location between sending the measurement control information and receiving the measurement report corresponding to the measurement control information to obtain handover request response information returned by a target base station, the time required for the handover can be reduced, the success rate of the handover can be improved and requirements of the user for quality of service can be met.

Continuing to refer to FIG. 1, a communication control method is applicable to a serving base station, including: between sending measurement control information and receiving a measurement report corresponding to the measurement control information, performing a preprocess for handover communication of a terminal device based on a current location of the terminal device to obtain handover request response information returned by a target base station.

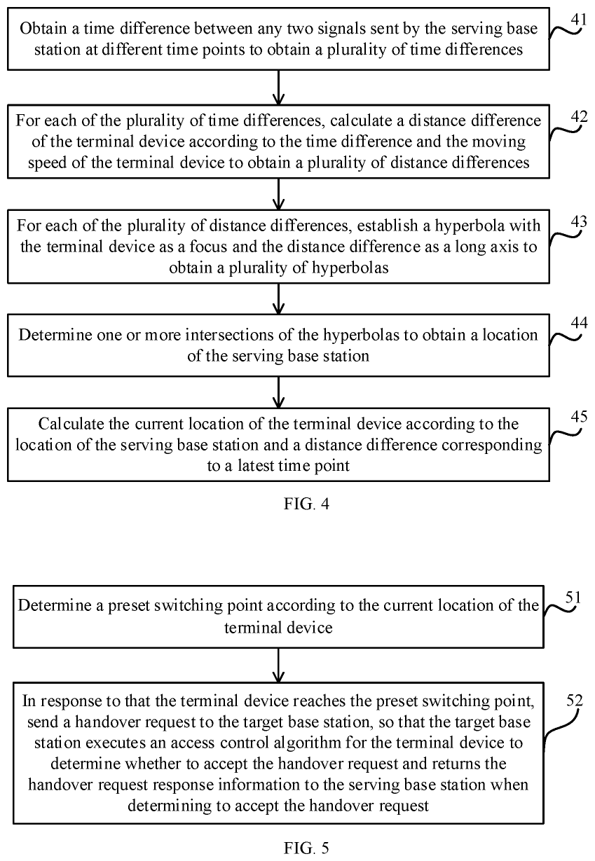

In this embodiment, the serving base station can perform a preprocess for handover communication of the terminal device based on the current location of the terminal device. Referring to FIG. 5, step 51 to step 52 are included.

In step 51, the serving base station can determine a preset switching point according to the current location of the terminal device.

In this step, the serving base station can obtain the current location reported by the terminal device. The way for the terminal device to obtain the current location can refer to the contents of step 34, which will not be repeated here.

In this step, the serving base station can determine the preset switching point according to the current location of the terminal device. The preset handover point refers to a location that triggers a handover, and a triggering condition can be that reference signal strength of a target cell exceeds parameter signal strength of a serving cell by 1 dB to 4 dB, or the triggering condition can be that the reference signal strength of the target cell exceeds a preset threshold. In one example, the above reference signal can be the RSRQ, and a value of the reference signal has a range of 3 dB to 20 dB.

In step 52, in response to that the terminal device reaches the preset switching point, the serving base station can send a handover request to the target base station, so that the target base station executes an access control algorithm for the terminal device to determine whether to accept the handover request and returns the handover request response information to the serving base station when determining to accept the handover request.

In this step, the terminal device can detect whether the terminal device reaches the preset switching point, send the handover request to the target base station in response to that the terminal device reaches the preset switching point, so that the target base station can execute the access control algorithm for the terminal device to determine whether to accept the handover request, and return the handover request response information to the serving base station when determining to accept the handover request. The access control algorithm is an algorithm based on load preset. which presets power and interference changes (delta I) brought to the target base station by an admission call access request according to a current power and interference situation (I_total_old) of the target base station and a call access request; if the target base station can move normally after accessing a new load, that is, I total_old+delta I<I_threshold. the admission is passed; otherwise, the admission is denied.

In this embodiment, after receiving the handover request response information. the serving base station can obtain the measurement report, wherein the measurement report is generated by the terminal device measuring signals of the serving base station and the target base station based on the measurement control information and is reported when the measurement report meets a preset measurement reporting criterion. Details can refer to step 24, which will not be repeated here.

In this embodiment, the serving base station can analyze the above measurement report and determine whether the preset handover decision algorithm is met. The preset handover decision algorithm can be implemented according to existing algorithms, which will not be limited here. When the measurement report meets the preset handover decision algorithm, the serving base station can deliver the handover command and the downlink resource allocated by the target base station to the terminal device, so that the terminal device can synchronize frequency with the target base station and reconfigure a radio resource control (RRC) connection according to the uplink resource and timing advance allocated by the target base station in response to receiving the handover command.

In this embodiment, after delivering the handover command, the serving base station can convert sequence number (SN) state data, that is, the serving base station is configured to convey uplink/downlink PDCP sequence number (PDCP SN) and a hyper frame number (HFN) states in the handover process, so that the target base station can clear about the above SN state data to facilitate the handover with the terminal device based on the SN state data. After obtaining the SN state data and the reconfiguration completion information uploaded by the terminal device, the target base station can send a path handover request to the core network. An access and mobility management function (AMF) in the core network can send a user-plane update request to a user port function (UPF) in the core network after receiving the path handover request, and the UPF can send the handover end identity to the terminal device after successfully handing over the downlink path. Moreover, the UPF can send the user-plane update reply to the AMF after successfully handing over the downlink path and the AMF returns a path handover request response to the target base station. The target base station can send a user context release instruction to the serving base station after receiving the path handover request response, and the serving base station can release resources corresponding to the terminal device after receiving the user context release instruction.

In the solution provided by the embodiment of the present disclosure, by performing a preprocess for handover communication of the terminal device between sending measurement control information and receiving a measurement report corresponding to the measurement control information to obtain handover request response information returned by the target base station, the time required for the handover can be reduced, the success rate of the handover can be improved and requirements of the user for quality of service can be met.

Continuing to refer to FIG. 1, a communication control method is applicable to a target base station, including:
after obtaining a handover request sent by a serving base station, executing, by the target base station, an access control algorithm for a terminal device to determine whether to accept the handover request; when determining to accept the handover request, returning handover request response information to the serving base station; and when it is determined that the handover request is not accepted, not returning the handover request response information, or returning handover request response information indicating that the handover request is not accepted.

After obtaining the SN state data and the reconfiguration completion information uploaded by the terminal device, the target base station can send a path handover request to the core network. An access and mobility management function (AMF) in the core network can send a user-plane update request to a user port function (UPF) in the core network after receiving the path handover request, and the UPF can send the handover end identity to the terminal device after successfully handing over the downlink path. Moreover, the UPF can send the user-plane update reply to the AMF after successfully handing over the downlink path and the AMF returns a path handover request response to the target base station. The target base station can send a user context release instruction to the serving base station after receiving the path handover request response, and the serving base station can release resources corresponding to the terminal device after receiving the user context release instruction.

In the solution provided by the embodiment of the present disclosure, by performing a preprocess for handover communication of the terminal device between sending measurement control information and receiving a measurement report corresponding to the measurement control information to obtain handover request response information returned by the target base station, the time required for the handover can be reduced, the success rate of the handover can be improved and requirements of the user for quality of service can be met.

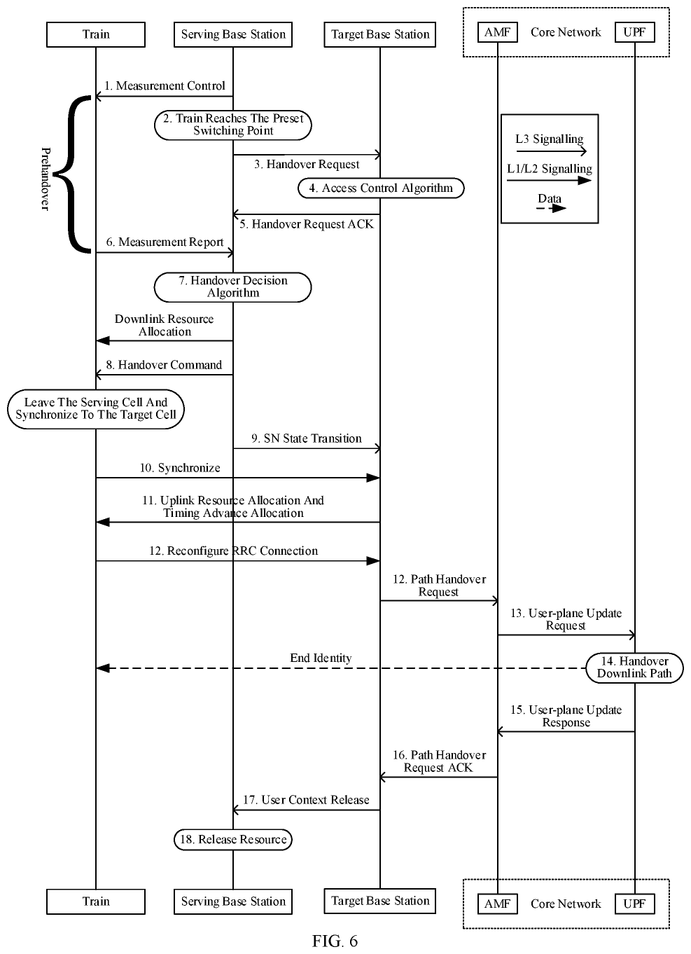

Hereinafter, a communication control method provided by the present disclosure will be described by taking the terminal device arranged on a train as an example. Referring to FIG. 6, including the following contents.

The train can receive a measurement control signal sent by a serving base station, measure signals of the serving base station and a target base station, and generate a measurement report; after obtaining measurement control information, the train can extract a preset measurement reporting criterion from the measurement control information; and after meeting the above measurement reporting criterion, the train can report the measurement report.

The train can receive a synchronization signal from the serving base station, analyze the synchronization signal to obtain a primary synchronization signal (PSS) sequence, and then obtain a secondary synchronization signal (SSS) sequence according to the PSS sequence. The PSS sequence can be used as a cell group number, and the SSS sequence can be used as a label in the cell, therefore, a physical cell identity (PCID) can be obtained according to the PSS sequence and the SSS sequence. In this way, the train can determine a location of the base station according to the above PCID.

The train can receive a plurality of signals from the same PCID and determine the current location of the train based on time differences of the signals. The train can constantly report the current location.

During the generation of the measurement report by the train, the serving base station obtains the current location of the train, determines the preset switching point, and sends a handover request to the target base station when the train reaches the preset switching point. The target base station executes an access control algorithm for the train and determines whether to accept the handover request. When it is determined to accept the handover request, the target base station returns handover request response information to the serving base station.

After obtaining the handover request response information, the serving base station can make a handover decision according to the measurement report and the preset handover decision algorithm, and deliver the handover command when the measurement report meets the preset handover decision algorithm. At the same time, the serving base station can also deliver a downlink resource allocated by the target base station for the train.

The serving base station converts sequence number (SN) state data to the target base station. The train can synchronize the frequency with the target base station and obtain the uplink resource and the timing advance allocated by the target base station; further, the train can reconfigure the radio resource control (RRC) connection according to the uplink resource and the timing advance. After reconfiguring the RRC connection, reconfiguration completion information is returned to the target base station.

After obtaining the SN state data and the reconfiguration completion information uploaded by the train, the target base station can send a path handover request to the core network. An access and mobility management function (AMF) in the core network can send a user-plane update request to a user port function (UPF) in the core network after receiving the path handover request, and the UPF can send the handover end identity to the train after successfully handing over the downlink path. Moreover, the UPF can send the user-plane update reply to the AMF after successfully handing over the downlink path and the AMF returns a path handover request response to the target base station. The target base station can send a user context release instruction to the serving base station after receiving the path handover request response, and the serving base station can release resources corresponding to the train after receiving the user context release instruction. In this way, this embodiment can make a switching speed faster when the train hands over and reduce the handover time of the train, therefore, the probability of the successful handover can be further improved and the continuity of communication can be ensured.

An embodiment of the present disclosure also provides a base station, including:
a processor; and
a memory for storing a computer program executable on the processor,
wherein the processor is configured to execute the computer program in the memory to implement the methods described in the above embodiments.

An embodiment of the present disclosure also provides a terminal device, including:
a processor; and
a memory for storing a computer program executable on the processor,
wherein the processor is configured to execute the computer program in the memory to implement the methods described in the above embodiments.

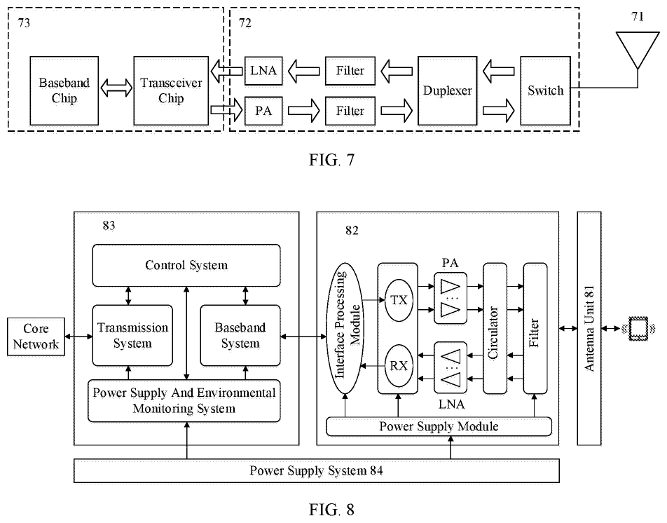

An embodiment of the present disclosure also provides a train. Referring to FIG. 7, the train includes an antenna module 71, a radio frequency front-end module 72 and a baseband information processing module 73, wherein
the antenna module 71 is configured to transmit and receive one or more electromagnetic wave signals;
the radio frequency front-end module 72 is configured to convert one or more radio frequency signals and the electromagnetic wave signals; and
the baseband information processing module 73 is configured to convert the radio frequency signals and one or more baseband signals,
wherein the baseband signals include at least one of a current location, measurement control information, measurement report, an uplink resource, timing advance, a reconfiguration completion instruction, a handover command, working frequency, a handover end identity or service data.

Continuing to refer to FIG. 7, the baseband information processing module 73 can include a baseband chip and a transceiver chip. The baseband chip is configured to modulate a baseband signal into an intermediate frequency signal or demodulate the intermediate frequency signal into the baseband signal. The transceiver chip can be used as a mixer for modulating the intermediate frequency signal into a high frequency signal of a target frequency (where the antenna operates) or modulating the high frequency signal into the intermediate frequency signal.

The radio frequency front-end module 72 can include a switch, a duplexer, a filter, a power amplifier (PA) and a low noise amplifier. The switch is configured to control transmitting signals or receiving signals. The filter is used to filter signals. The PA is configured to amplify radio frequency signals. The low noise amplifier is configured to amplify a signal with a specific frequency and filter signals with other frequencies.

Combining with FIG. 6 and FIG. 7, a communication control process of the train can include the following contents.

In an uplink stage, the baseband signal is input to the baseband chip and modulated into the intermediate frequency signal by the baseband chip; the intermediate frequency signal enters the transceiver chip, and is modulated into the high frequency signal of the target frequency by the transceiver chip; the high frequency signal enters the power amplifier, and is amplified by the power amplifier to obtain an amplified high frequency signal; the amplified high frequency signal enters the filter and then enters the duplexer and switch after filtering, and the filtered high frequency signal passes through the antenna and radiates to an external space.

In a downlink stage, an electromagnetic wave signal is received by the antenna and turned into the high frequency signal; the high frequency signal enters the switch, the duplexer and the filter, and then enters the low noise amplifier, which is configured to amplify the signal with the specific frequency and filter signals with other frequencies; the amplified high frequency signal enters the transceiver chip and becomes the intermediate frequency signal; the intermediate frequency signal enters the baseband chip and becomes the baseband signal.

The train can communicate with the serving base station and transmit and receive service data according to the above baseband signal. When it is necessary for the train to hand over communication, by combining an architecture shown in FIG. 7 with the communication control method shown in FIG. 6, it is possible to switch the train from communicating with the serving base station to communicating with the target base station, thereby achieving the effect of uninterrupted communication of the train.

An embodiment of the present disclosure also provides a base station. Referring to FIG. 8, the base station can include an antenna unit 81, a radio frequency front-end unit 82, a central unit, a distribution unit 83 and a power supply system 84, wherein
the antenna unit 81 is configured to receive and transmit one or more electromagnetic wave signals;
the radio frequency front-end unit 82 is configured to combine and divide paths, process data and modulate and demodulate one or more radio frequency signals and baseband signals; and
the central unit and the distribution unit 83 are configured to process the baseband signals and exchange signaling with a core network.
the power supply system 84 is configured to supply power to respective units.

The central unit and the distribution unit 83 can include a control system, a transmission system, a baseband system and a power supply and environmental monitoring system. The transmission system is configured to exchange signaling with the core network. The baseband system is configured to realize baseband data transmission with the radio frequency front-end unit. The control system is configured to control the transmission system and the baseband system to operate. The power supply and environmental monitoring system is configured to adjust input power of the baseband system and the transmission system according to environmental conditions.

The radio frequency front-end unit 82 can include an interface processing module, a transmitting module TX, a receiving module RX, a power amplifier (PA), a low noise amplifier, a circulator and a filter. The interface processing module is configured to realize a conversion between the baseband signals with the high frequency signal, which is equivalent to a combination of the baseband chip and the transceiver chip in FIG. 7. The transmitting module TX can realize a digital-to-analog conversion of the high frequency signal. The receiving module RX is configured to realize an analog-to-digital conversion of the high frequency signal. The PA can perform power amplification on the high frequency signal. The low noise amplifier is configured to amplify the signal with the specific frequency and filter signals with other frequencies. The circulator is configured to realize a switching of receiving and transmitting signals.

Combining FIG. 6 and FIG. 8, the base station can be used as a serving base station or a target base station. When it is used as the serving base station, the base station can communicate with the train and transmit the signaling and the service data. When it is necessary for the train to hand over communication, the communication control method shown in FIG. 6 can be performed to provide a handover communication service for the train. When it is used as the target base station, the communication control method shown in FIG. 6 can be performed to receive a handover request and provide communication service for the train instead of the serving base station, thereby achieving the effect of uninterrupted communication of the train. In an exemplary embodiment, there is provided a computer readable storage medium, for example, including a memory for storing an executable computer program, the above executable computer program can be executed by a processor to implement the methods described in the above embodiments. The readable storage medium can be a ROM, a random access memory (RAM), a CD-ROM, a magnetic tape, a floppy disk, an optical data storage device, and the like.

Other implementations of the present disclosure will be apparent to those skilled in the art from consideration of the specification and practice of the present disclosure herein. The present disclosure is intended to cover any variations, uses, modification or adaptations that follow the general principles thereof and include common knowledge or conventional technical means in the related art that are not disclosed in the present disclosure. The specification and embodiments are exemplary only, with a true scope and spirit of the present disclosure being indicated by the following claims.

It should be understood that the present disclosure is not limited to the above described structures shown in the drawings. and various modifications and changes can be made to the present disclosure without departing from the scope thereof. The scope of the present disclosure is to be limited only by the appended claims.

1. A communication control method, being applicable to a serving base station, comprising:
between sending measurement control information and receiving a measurement report corresponding to the measurement control information, performing a preprocess for handover communication of a terminal device based on a current location of the terminal device to obtain handover request response information returned by a target base station.

2. The method according to claim 1, wherein performing a preprocess for handover communication of the terminal device based on the current location of the terminal device comprises:
determining a preset switching point according to the current location of the terminal device; and
in response to that the terminal device reaches the preset switching point, sending a handover request to the target base station, so that the target base station executes an access control algorithm for the terminal device to determine whether to accept the handover request and returns the handover request response information to the serving base station when determining to accept the handover request.

3. The method according to claim 1, further comprising:
obtaining the measurement report, wherein the measurement report is generated by the terminal device measuring signals of the serving base station and the target base station based on the measurement control information and is reported when the measurement report meets a preset measurement reporting criterion; and
delivering a handover command to the terminal device when the measurement report meets a preset handover decision algorithm, so that the terminal device synchronizes frequency with the target base station and reconfigures a radio resource control (RRC) connection according to an uplink resource and timing advance allocated by the target base station in response to receiving the handover command.

4. The method according to claim 3, further comprising:
transferring sequence number (SN) state data to the target base station after delivering the handover command, so that the target base station sends a path handover request to a core network and sends a user context release instruction to the serving base station after obtaining a path handover request response; and
in response to obtaining the user context release instruction, releasing resources corresponding to the terminal device.

5. A communication control method, being applicable to a terminal device, comprising:
obtaining a current location of the terminal device and measurement control information sent by a serving base station;
reporting the current location to the serving base station, so that the serving base station performs a preprocess for handover communication of the terminal device based on the current location to obtain handover request response information returned by a target base station;
measuring signals of the serving base station and the target base station based on the measurement control information and generating a measurement report;
reporting the measurement report to the serving base station when the measurement report meets a preset measurement reporting criterion, so that the serving base station makes a handover decision according to the measurement report and a preset handover decision algorithm after obtaining the handover request response information and delivers a handover command when the measurement report meets the preset handover decision algorithm; and
in response to receiving the handover command, synchronizing frequency with the target base station and reconfiguring a radio resource control (RRC) connection according to an uplink resource and timing advance allocated by the target base station.

6. The method according to claim 5, wherein obtaining the current location of the terminal device comprises:
obtaining a reference primary synchronization signal (PSS) sequence;
obtaining a secondary synchronization signal (SSS) sequence according to the reference PSS sequence;
determining a physical cell identity (PCID) according to the reference PSS sequence and the SSS sequence, and determining a base station location according to the PCID; and
determining the current location of the terminal device according to the base station location, a moving speed of the terminal device and a signal time difference.

7. The method according to claim 6, wherein determining the current location of the terminal device according to the base station location, the moving speed of the terminal device and the signal time difference comprises:
obtaining a time difference between any two signals sent by the serving base station at different time points to obtain a plurality of time differences;
for each of the plurality of time differences, determining a distance difference moved by the terminal device according to the time difference and the moving speed of the terminal device to obtain a plurality of distance differences;
for each of the plurality of distance differences, establishing a hyperbola with the terminal device as a focus and the distance difference as a long axis to obtain a plurality of hyperbolas;
determining one or more intersections of the hyperbolas to obtain a location of the serving base station; and
determining the current location of the terminal device according to the location of the serving base station and a distance difference corresponding to a latest time point.

8. The method according to claim 5, wherein obtaining the current location of the terminal device comprises:
when passing through a ground transponder, transmitting, by an inquiry transponder in the terminal device, a radio frequency signal to active the ground transponder between tracks, so that the ground transponder transmits preset information comprising location information; and
obtaining the location information in the preset information, and taking the location information as the current location of the terminal device.

9. A base station, comprising:
a processor; and
a memory for storing a computer program executable on the processor,
wherein the processor is configured to execute the computer program in the memory to implement the method according to claim 1.

10. A terminal device, comprising:
a processor; and
a memory for storing a computer program executable on the processor,
wherein the processor is configured to execute the computer program in the memory to implement the method according to claim 5.

11. A train comprising an antenna module, a radio frequency front-end module and a baseband information processing module, wherein
the antenna module is configured to transmit and receive one or more electromagnetic wave signals;
the radio frequency front-end module is configured to convert one or more radio frequency signals and the electromagnetic wave signals; and
the baseband information processing module is configured to convert the radio frequency signals and one or more baseband signals,
wherein the baseband signals comprise at least one of a current location, measurement control information, measurement report, an uplink resource, timing advance, a reconfiguration completion instruction, a handover command, working frequency, a handover end identity or service data.

12. (canceled)

13. A computer readable storage medium, wherein, when an executable computer program in the computer readable storage medium is executed by a processor, the processor is configured to implement the method according to claim 1.
